(19) United States
(12) Patent Application Publication
(10) Pub. No.: US 2006/0174419 A1
(43) Pub. Date: Aug. 10, 2006

(54) Method of rendering a fabric elastic by means of caustic treatment and relaxation machine for performing said method and fabric thus obtained

(76) Inventor: Patrick Decouvelaere, Docelles (FR)

Correspondence Address: Gary M Cohen, Strafford Building Number Three, 125 Strafford Avenue Suite 300, Wayne, PA, 19087-3318, US

(21) Appl. No.: 10/565,458

(22) PCT Filed: Jul. 23, 2004
(86) PCT No.: PCT/FR04/01973

§ 371 Date: Jan. 20, 2006

(30) Foreign Application Priority Data
Jul. 25, 2003 (FR) 0309271

(51) Int. Cl. B32B 5/02; B32B 27/04; B32B 9/04; C11D 3/00

(52) U.S. Cl. 8/115.51; 442/59; 442/104; 442/105; 442/152; 442/153

(57) ABSTRACT

The invention relates to a method of treating a fabric by impregnation with a metal peroxide, characterized in that it consists in applying to a fabric, for example a de-sized and/or previously bleached hydrophilic one, whose weft (or inversely whose warp) consists of natural or artificial cellulose fibers: impregnation (I) with a metal peroxide, leaving the weft (or inversely the warp) of the fabric free for a period of time necessary for the swelling of the fiber constituting the weft (or inversely the warp) of the fabric and for the modification of the cellulose, at least one relaxation with no weft tension (or inversely with no warp tension) by passage in air during which the weft (or inversely the warp) swells and then assumes the form of a spring, after shrinkage, at least one rinsing, at least one washing, at least one squeezing. The invention also relates to the elastic fabrics obtained by the method and to the implementing machines.

The invention relates to a new method of rendering a fabric elastic, a machine for implementing the method, and the fabric obtained by the method.

More particularly, the applicant has found a solution to a problem not yet solved consisting in giving a characteristic of elasticity to a fabric produced with fibers that are naturally non-elastic, that is to say before treatment.

This solution consists in a mechanical and chemical method of treating a fabric by impregnation with caustic soda or with another metal peroxide, characterized in that it consists in applying to a hydrophilic fabric, for example a de-sized and/or previously bleached one, whose weft (or inversely whose warp) consists of threads made of natural or artificial cellulose fibers:
impregnation with a metal peroxide, leaving the weft (or inversely the warp) of the fabric free for a period of time necessary for the swelling of the fiber constituting the weft (or inversely the warp) of the fabric and for the modification of the cellulose,
at least one relaxation with no weft tension (or inversely with no warp tension) by passage in air during which the weft (or inversely the warp) swells and then assumes its spring shape, after shrinkage,
at least one rinsing,
at least one washing,
at least one squeezing.

More particularly but not limitatively, the time of alkaline contact at 14 to 25° Baumé is less than 5 minutes.

Preferably, it comprises, after the impregnation, at least a first vigorous squeezing, for example with a driving off rate of at least 70% of the product, followed by a first relaxation passage in air, for example of at least one minute.

Preferably, a fabric is used whose weft (or inversely whose warp) consists of cellulose-based fibers and a fabric whose construction allows the swelling of the weft (for example by about 30% to 50%) and a strong squeezing.

An implementing machine principally and successively comprises:
an impregnation station,
at least a first squeezing station,
at least a first relaxation station,
possibly a direction-changing roller,
possibly a second squeezing station,
possibly a second relaxation station,
possibly a rinsing station,
one or two washing stations,
a final squeezing station,
a rolling up station,
means of regulating the speed of progress of the fabric capable of managing the duration of impregnation with caustic soda and the duration of relaxation in air.

The fabric obtained is a cellulose-based elastic fabric whose weft (or inversely whose warp) consists of cellulose fibers not naturally elastic before application of the method and having properties of elasticity in the weft direction (or inversely in the warp direction) which are conferred upon it by the method. The warp (or inversely the weft) can be made of other materials but must be able to withstand the peroxide treatment. By way of example, it is possible to use certain synthetic materials such as polyester.

The invention will be better understood with the help of the description given below with reference to the following appended figures:

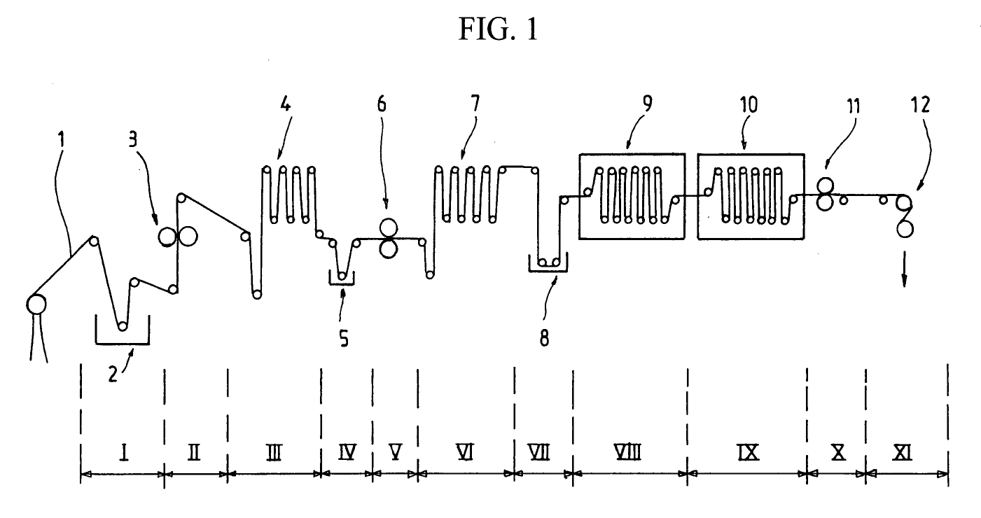

FIG. 1 is a diagrammatic representation of the method according to the invention,

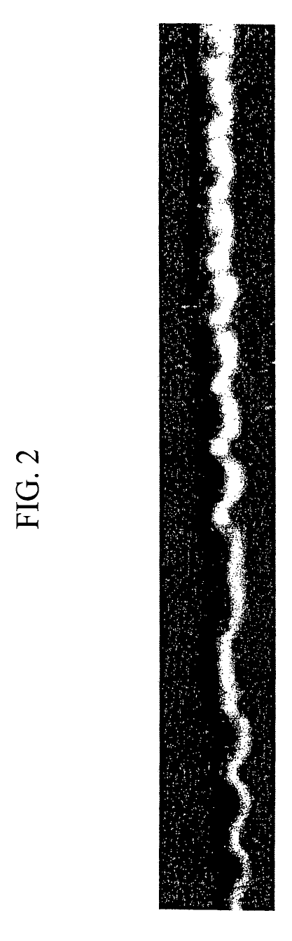

FIGS. 2, 3 and 4 are enlarged views of threads based on cellulose fibers, given by way of nonlimiting example, having undergone a treatment according to the invention,

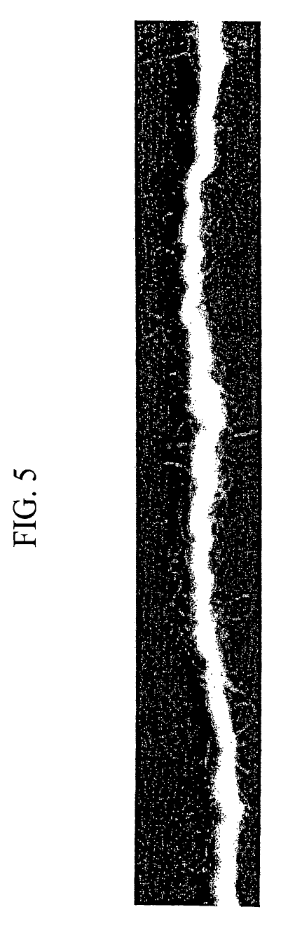

FIG. 5 is an enlarged view of a thread based on cellulose fibers, not having undergone treatment according to the invention.

In order to simplify the description and the reading there is described hereafter by way of example a method and a machine according to the invention which make it possible to render a fabric elastic in the weft direction.

In order to obtain elasticity in the warp direction, it is necessary to inverse the principle of the method and that of the machine.

Conventionally, the rates given below for the squeezing operations are the driving off rates.

According to the nonlimiting example shown in FIG. 1, there is firstly applied to a fabric, for example a hydrophilic and/or previously bleached fabric (1) an impregnation (I) with caustic soda in a bath (2), leaving the fabric free (without weft tension) in such a way as to allow the weft to swell by impregnation and to become modified. Other metal peroxides can also be suitable and the treatment can be suitable for a non-bleached but hydrophilic fabric such as for example a de-sized fabric.

The speed of progress of the fabric is regulated in such a way as to have a predetermined duration of impregnation which is sufficient for a maximum swelling of the weft, whilst remaining below a threshold of transformation, and/or of fixing, and/or of deterioration of the fiber.

After its exit from the bath (2) of caustic soda, the fabric undergoes a partial squeezing (II) in a conventional device of the squeezing mangle type (3). By way of example, a strong squeezing is carried out with a driving off rate of at least 70%; other rates are possible but the squeezing must be strong in order to give a shape to the cellulose thread.

Then, the fabric undergoes a relaxation III; in order for this to happen, it is taken into a station (4) for relaxation over rollers, in which the length of travel in free air in zigzag fashion between the rollers is predetermined and sufficient for the weft of the fabric to assume its shape and its shrinkage under the action of the caustic soda.

After passage (IV) through a tub with a direction changing roller (5) that is empty or filled with caustic soda depending on the characteristics of the fabric (material, weave, weight), the fabric undergoes a second squeezing (V) in a squeezing mangle (6) followed by a second relaxation (VI) without weft tension which perfects the shrinkage in width of the fabric and its “spring effect” which gives the elasticity of the fabric.

The fabric possibly undergoes a cold rinsing (VII) in a tank (8), then at least one or two washings (VIII, IX) in overflowing water tanks (9, 10).

The fabric passes through these relaxation stations (4) and (7) without weft tension but with warp tension, and for a time that is sufficient to allow the weft to shrink, and predetermined according to the characteristics of the fiber and of the fabric.

At the output, the fabric has acquired a “spring” effect or elastic effect memory.

After final squeezing (X) in rollers (10), it is wound (XI) on a cylinder (12) and can then undergo treatments such as hot washing and/or neutralization of the caustic soda in an acid bath and normal finishing treatments such as dyeing, drying, stiffening, Tumbler drying to release tensions, etc. It can be important to finish the treatment with a passage in a Tumbler machine in order to obtain good elasticity, excellent stability and a good feel. The fabric then assumes a state of equilibrium.

The characteristics hereinbelow are given as a preferred but nonlimiting example.

Treated fabric:
linen warp, Tencel® weft,
square weave,
fabric of rather loose construction allowing the weft to swell sufficiently, for example by about 30%, this construction can be calculated according to a mathematical model.

Impregnation:
caustic soda bath at 14 to 25° Baumé,
duration: less than 5, for example from 3 to 4 minutes

1^{st} squeezing: vigorous, for example at least 70%.

1^{st} relaxation in air

2^{nd} squeezing: vigorous, for example at least 70%.

2^{nd} relaxation in air.

Rinsings and washings: in water: (for example in cold water, about 10 m per minute).

Final squeezing: vigorous, for example at least 80%.

Neutralization of the caustic soda and hot water washing.

Tests on the fabric obtained showed an elasticity of the order of 15 to 25% with good behavior in use since it improves with the number of washings in the user's home and is not sensitive to the temperature of the water.

The method of the invention applies more generally to all fabrics whose weft (or inversely whose warp) consists of natural cellulose fibers such as for example made of linen or artificial fibers such as, for example, Tencel® or Lyocell®.

The warp (or inversely the weft) can consist of natural or artificial or synthetic fibers.

The invention also applies to a machine specially designed to implement the method.

This machine principally and successively comprises:
an impregnation station,
at least a first squeezing station (3),
at least a first relaxation station (4),
possibly a tank or bucket (5) for use empty or with the addition of peroxide, whose direction-changing roller is used to prevent folds on entry to the next station, the filling of the bucket (5) making it possible to reduce the passage time,
a second squeezing station (6) which is not obligatory but can improve the effectiveness of the first passage,
a second relaxation station (7),
possibly a rinsing station (8), knowing that it is also possible to neutralize in a washer after the passage through the machine,
one washing station (compartment) or two washing stations (compartments) (9) (10),
a final squeezing station (11),
a rolling up station (12).

It also comprises means of regulating the speed of progress and the warp tension that is regulated according to the durations necessary for the impregnation and for the relaxations of the weft in air. The machine also comprises all of the control means necessary for its functioning and within the scope of those skilled in the art.

The machine described above makes it possible to obtain elasticity in the weft direction, that is to say in the width of the fabric. Throughout the treatment, the warp is tensed and causes the weft, which remains free, to undulate and which then becomes fixed in an undulated state. There is a crushing of the weft threads between the warp threads and/or at the warp and weft junction which remains in memory over the fabric after processing.

The invention that has just been described exhibits the following advantages in particular:
the method allows the development of a mathematical model which is capable of predicting the characteristics of the fabric after treatment according to the constriction of the fabric, the weave, the mixture, the width, the elasticity, the sought weight, etc., and therefore to define the parameters of the treatment according to the fabric model previously studied and/or calculated,
a large number of natural or artificial cellulose fibers are suitable. It is necessary to adapt the concentration of the caustic soda or of the metal peroxide to the type of cellulose but a natural cellulose fiber like linen or an artificial fiber like Lyocell (the Tencel brand for example) are perfectly adapted to the method,
on Lyocell fibers, the treatment partially transforms the crystalline nature of the cellulose into amorphous cellulose,
the warp and weft stability on washing the fabric obtained is very greatly improved and sanforizing is not necessary after the dyeing. The shape memory fixes the fabric and a relationship gives rise to a mechanical stability of the fabric,
the feel is improved,
the elasticity is not sensitive to the temperature of water up to 100° C.,
the fabric fractures less during dyeing, which reduces defects, and fractures less on washing, thus facilitating ironing,
with Lyocell, there is a great reduction in the fibrillation during the treatment (dyeing, stiffening) which improves the appearance of the surface of the fabric. The fabric can still be fibrillated using enzymes,
the fabric can be modeled and the industrial process is reliable and reproducible,
it is not necessary to heat fix the fabric as for elasthanne®, which is a great advantage for obtaining well blued whites which become yellow with heat.

Furthermore, the fabric according to the invention can be identified on the one hand by its straight and tensed warp (or inversely its weft) whereas the weft is undulated and has been locked or fixed in a spring state by a crushing at the junction of the weft fibers and the warp fibers, at the time of the shrinkage, and on the other hand by a transformation, at least partial, of the fibers of crystalline type into amorphous cellulose.

It is also noted that the fabric according to the invention can be identified by its weft and by its warp, in comparison with a fabric not having undergone the treatment, by the following points:
the weft thread (or inversely the warp thread) of the fabric is less pilous, less round, more flattened, more crushed. It is in the shape of a fine ribbon or a fine strip and has increased brightness under the microscope,
the weft (or inversely the warp) assumes a very marked and very visible undulation. Its shape perfectly takes account of the weave of the fabric. It memorizes a spring state with greater crushing in the space between two warp threads,
the weft (or inversely the warp) assumes elasticity according to the construction and a good return force as long as the elastic limit is not exceeded. Its ability to withstand torsion is much greater than for a non-treated weft. This is due to the shape memory.
in the case of an open-end thread, the fagoting of the fibers after treatment reveals, under the microscope, a tendency to create rings around the thread,
the warp (or inversely the weft) thread is straighter, less undulated with weaker flattening than on a conventional fabric. It is much less flattened than the weft and exhibits less marked undulation. Its elasticity is weak on cellulose.

Whatever cellulose is used, the treatment changes the proportion of the percentages of cellulose I, of cellulose II, both crystalline, and of amorphous cellulose.

The treatment renders the new structure of the cellulose irreversible and makes it possible to obtain good overall mechanical equilibrium.

FIGS. 2, 3 and 4 show the appearance of a weft (or inversely a warp) thread, of different weaves, treated by the method according to the invention.

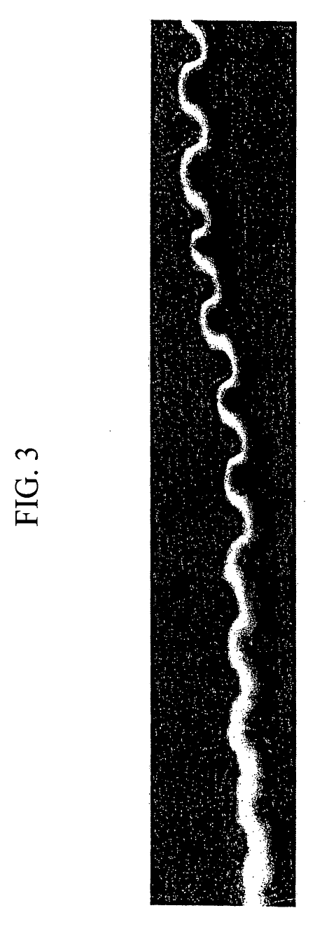

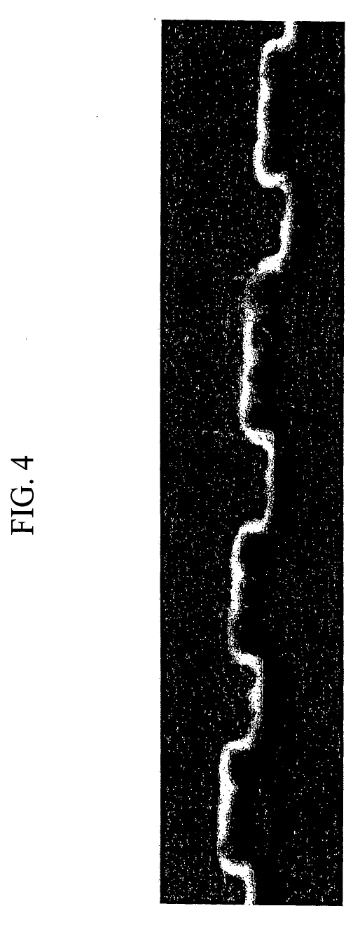

They take advantage of the shape memory by the flattened structure of the thread, by its crushing at the points of contact and by the undulations related to the weave for example:
FIG. 2: irregular weave. The undulation is marked and the weft twists,
FIG. 3: regular weave with small loose threads (or passages),
FIG. 4: regular weave with large loose threads:

It takes good advantage of the crushing caused by the warp (or inversely by the weft),
FIG. 5 shows a non-elastic thread based on cellulose fibers taken from a fabric not treated by a method of the invention and which will assume a characteristic of elasticity after treatment.

A fabric according to the invention is therefore a fabric that is not naturally elastic, the elasticity in the weft direction (or inversely in the warp direction) is conferred upon it by chemical and mechanical treatment which modifies the cellulose of the thread constituting the weft (or inversely the warp) in order to give it a shape memory, the memorized shape being due to the impression of the weave of the fabric during shrinkage.

After treatment, the warp (or inversely the weft) is straight and tensed whilst the weft is undulated according to a shape or impression depending on the weave of the fabric.

The expression “not naturally elastic” signifies that the fabric and/or the thread, in the absence of any treatment, does not have any characteristic of elasticity and, in particular, it does not comprise threads that are elastic or rendered elastic by manufacture (for example a wound thread or a thread with an elastic core).

1. A method of treating a fabric by impregnation with a metal peroxide, characterized in that it consists in applying to a fabric, for example a de-sized and/or previously bleached hydrophilic one, whose weft (or inversely whose warp) consists of threads made of natural or artificial cellulose fibers:
impregnation (I) with a metal peroxide, leaving the weft (or inversely the warp) of the fabric free for a period of time necessary for the swelling of the fiber constituting the weft (or inversely the warp) of the fabric and for the modification of the cellulose,
at least one relaxation (III) with no weft tension (or inversely with no warp tension) by passage in air during which the weft (or inversely the warp) swells and then assumes its spring shape, after shrinkage,
at least one rinsing,
at least one washing,
at least one squeezing.

2. The method as claimed in claim 1, characterized in that the peroxide used is caustic soda at 14 to 25° Baumé.

3. The method as claimed in one of claims 1 or 2, characterized in that the time of alkaline contact at 14 to 25° Baumé is less than 5 minutes.

4. The method as claimed in one of claims 1 to 3, characterized in that it comprises, after the impregnation (I), at least a first vigorous squeezing (II) out of the product, followed by a first relaxation passage (III) in air.

5. The method as claimed in one of claims 1 to 4, characterized in that a weft (or inversely a warp) consisting of artificial fiber such as Tencel® is used.

6. The method as claimed in one of claims 1 to 4, characterized in that a weft (or inversely a warp) consisting of natural fibers such as linen is used.

7. The method as claimed in one of claims 1 to 6, characterized in that a fabric is used whose construction allows the weft (or inversely the warp) to swell.

8. A machine for treating a fabric of the type comprising an impregnation station with a tank (1) containing a peroxide, characterized in that:
it is designed for the implementation of the method as claimed in claims 1 to 7,
it principally and successively comprises:
an impregnation station,
at least a first squeezing station (3),
at least a first relaxation station (4),
possibly a direction-changing roller or mangle (5), possibly filled with peroxide,
possibly a second squeezing station (6),
possibly a second relaxation station (7),
possibly a rinsing station (8),
one or two washing stations (9) (10),
a final squeezing station (11),
a rolling up station,
means of regulating the speed of progress of the fabric capable of managing the duration of impregnation with caustic soda and the duration of relaxation in air.

9. A cellulose-based fabric whose weft consists of cellulose fibers that are not naturally elastic, characterized in that it is rendered elastic by a treatment based on metal peroxide having modified the cellulose in order to give it shape memory.

10. The cellulose-based fabric as claimed in claim 10, characterized in that it is rendered elastic in the weft direction by a treatment with a metal peroxide and in that its straight warp is tense whereas the weft is undulated and has been fixed in a spring state.

11. The cellulose-based fabric as claimed in one of claims 10 or 11, characterized in that it is obtained by a method as claimed in one of claims 1 to 7.

12. A cellulose-based fabric whose warp consists of threads made of cellulose fibers that are not naturally elastic, characterized in that it is rendered elastic by a treatment based on metal peroxide having modified the cellulose in order to give it shape memory.

13. The cellulose-based fabric as claimed in claim 12, characterized in that it is rendered elastic in the warp direction by a treatment with a metal peroxide and in that its straight weft is tense whereas the warp is undulated and has been fixed in a spring state.

14. The cellulose-based fabric as claimed in one of claims 12 or 13, characterized in that it is obtained by a method as claimed in one of claims 1 to 7.
